(19) United States
(12) Patent Application Publication
(10) Pub. No.: US 2019/0079919 A1
(43) Pub. Date: Mar. 14, 2019

(54) WORK SUPPORT SYSTEM, MANAGEMENT SERVER, PORTABLE TERMINAL, WORK SUPPORT METHOD, AND PROGRAM

(71) Applicant: NEC Corporation, Minato-ku, Tokyo (JP)

(72) Inventors: Motohiko SAKAGUCHI, Tokyo (JP); Masahiro TABUCHI, Tokyo (JP)

(73) Assignee: NEC Corporation, Minato-ku, Tokyo (JP)

(21) Appl. No.: 16/082,335

(22) PCT Filed: Jun. 20, 2017
(86) PCT No.: PCT/JP2017/022626

§ 371 Date: Sep. 5, 2018

(30) Foreign Application Priority Data
Jun. 21, 2016 (JP) 2016-122804

(51) Int. Cl. G06F 17/27; G06F 17/22; G10L 15/08; G06F 3/16

(52) U.S. Cl. CPC G06F 17/2775; G06F 17/2276; G10L 2015/088; G06F 3/167; G10L 15/08

(57) ABSTRACT

A management server includes an acceptance part configured to accept slip information that associates and holds work item information indicating a work item and a work result candidate(s), a dictionary registration part configured to register the work result candidate(s) included in the slip information in a dictionary, in association with the work item or the slip information, a storage part configured to associate and store the slip information and the dictionary, and a transmission part configured to transmit the slip information together with the associated dictionary when the transmission part transmits the slip information.

### CROSS-REFERENCE TO RELATED APPLICATIONS

The present invention is based upon and claims the benefit of the priority of Japanese Patent Application No. 2016-122804 (filed on Jun. 21, 2016), the disclosure of which is incorporated herein in its entirety by reference.

### TECHNICAL FIELD

The present invention relates to a work support system, a management server, a portable terminal, a work support method, and a program. More specifically, the invention relates to a work support system, a management server, a portable terminal, a work support method, and a program for supporting hands-free checking and inspection work by a worker.

### BACKGROUND

In recent years, a speech recognition technology for converting a human voice into a character has remarkably made progress. With this progress, the speech recognition technology has begun to be applied to speech input for business support in a contact center, support of creation of a record of proceedings, or checking and inspection work in a factory or an office, as well.

As a related art, Patent Literature (PTL) 1 describes a spoken dialogue system for smoothly carrying out a dialogue between a user and the system even when the system erroneously recognizes a user's utterance.

### CITATION LIST

### Patent Literature

### [PTL 1]

JP Patent Kokai Publication No. JP2005-316247A

### SUMMARY

### Technical Problem

The disclosure of the above-listed Patent Literature is incorporated herein in its entirety by reference. The following analysis has been made by the inventors of the present invention.

Usually, there are a wide range of items for checking and inspection (hereinafter, referred to as “work items”) in checking and inspection work in a factory or an office. Accordingly, a worker needs to sequentially carries out the work while referring to a paper-based list of the work items. In this case, the worker needs to temporarily suspend the work in order to refer to the list of the work items, so that reduction of efficiency of the work may be brought about.

When a lot of the work items are executed, the worker needs to record (store) a result of work each time he executes each work item and obtains the result of the work. However, when he inputs the result of the work into a predetermined document by hand or when he manually inputs the result of the work into a tablet, a smartphone, or a laptop (hereinafter, referred to as a “portable terminal”), the worker needs to suspend the work once, so that further reduction of the efficiency of the work may be brought about.

Accordingly, in order to achieve improvement in the efficiency of the work when the checking and inspection work is carried out, it is desirable to perform both checking of the work item to be executed and input of the result of the work, in a hands-free (empty-handed) state. As a technology for accommodating such a request, a technology for performing speech input of a result of work while guiding a work item by voice has been put to practical use.

By the way, in checking and inspection work of a product that is carried out in a factory assembly (production) line, an environment around a worker may also be under high noise. When a speech input of a result of the work is performed under such an environment, a result of the input may not be necessarily the one intended by the worker, so that the worker needs to repeat an utterance or needs to manually input the result of the work again instead of the speech input, until a correct input result is obtained.

In the technology described in Patent Literature 1, the following complex processes are needed. That is, in order to modify the utterance of the user that has been erroneously recognized by the system, a dialogue history configured to record a change in a dialogue state is provided, a rule for recognizing a user's utterance to be corrected is created using information in the dialogue history and a template provided in advance, the utterance of the user is regarded as the utterance to be corrected and then a transition is made to a process of modifying the erroneous recognition when the utterance of the user is recognized by using the created rule. Even if the technology in Patent Literature 1 has been adopted, a repeated utterance of the user is needed.

In order to avoid such a repeated speech input by the worker, it is desirable to reduce a possibility of erroneous recognition of a speech input by the worker as much as possible even if the work environment is under the high noise.

Then, it becomes a problem to improve voice recognition performance for a speech input associated with checking and inspection work that is carried out under high noise. An object of the present invention is to provide a work support system, a management server, a portable terminal, a work support method, and a program that contribute to resolving the challenge mentioned above.

### Solution to Problem

A management server according to a first aspect of the present invention may include: an acceptance part configured to accept slip information that associates and holds work item information indicating a work item and a work result candidate(s); a dictionary registration part configured to register the work result candidate(s) included in the slip information in a dictionary, in association with the work item or the slip information; a storage part configured to associate and store the slip information and the dictionary; and a transmission part configured to transmit the slip information together with the associated dictionary when transmission part transmits the slip information.

A portable terminal according to a second aspect of the present invention may include: a communication part configured to obtain slip information including work item information indicating a work item and a dictionary associated with the slip information; a presentation part configured to present the work item information; a speech recognition part configured to perform speech recognition of a speech input accepted for the work item information, using the dictionary; and a storage part configured to hold a result of the speech recognition, as a work result with respect to the work item information.

A work support system according to a third aspect of the present invention may include the management server and the portable terminal.

A work support method according to a fourth aspect of the present invention may include the steps of, by a management server: accepting slip information that associates and holds work item information indicating a work item and a work result candidate(s); registering the work result candidate(s) included in the slip information in a dictionary, in association with the work item or the slip information; associating and storing the slip information and the dictionary; and transmitting the slip information together with the associated dictionary when transmitting the slip information.

A work support method according to a fifth aspect of the present invention may include the steps of, by a portable terminal: obtaining slip information including work item information indicating a work item and a dictionary associated with the slip information; presenting the work item information; performing speech recognition of a speech input accepted for the work item information, using the dictionary; and holding a result of the speech recognition, as a work result with respect to the work item information.

A program according to a sixth aspect of the present invention causes a computer to execute the processes of: accepting slip information that associates and holds work item information indicating a work item and a work result candidate(s); registering the work result candidate(s) included in the slip information in a dictionary, in association with the work item or the slip information; associating and storing the slip information and the dictionary; and transmitting the slip information together with the associated dictionary when transmitting the slip information.

A program according to a seventh aspect of the present invention causes a computer to execute the processes of: obtaining slip information including work item information indicating a work item and a dictionary associated with the slip information; presenting the work item information; performing speech recognition of a speech input accepted for the work item information, using the dictionary; and holding a result of the speech recognition, as a work result with respect to the work item information.

The program can also be provided as a program product recorded in a non-transitory computer-readable storage medium.

### Advantageous Effects of Invention

According to the work support system, the management server, the portable terminal, the work support method, and the program according to the present invention, it becomes possible to improve speech recognition performance for a speech input associated with checking and inspection work that is carried out under high noise.

### BRIEF DESCRIPTION OF THE DRAWINGS

FIG. 1 is a diagram illustrating a configuration of a work support system according to an exemplary embodiment.

FIG. 2 is a block diagram illustrating a configuration of a work support system according to a first exemplary embodiment.

FIG. 3 is a diagram illustrating data held by a management server and a portable terminal in the work support system according to the first exemplary embodiment.

FIG. 4 is a table illustrating a format (format) of a work slip in the first exemplary embodiment.

FIG. 5 is a diagram illustrating a format of an option that is described in the work slip in the first exemplary embodiment.

FIG. 6 is a diagram illustrating a format of a numerical value that is described in the work slip in the first exemplary embodiment.

FIG. 7 is a diagram illustrating a custom dictionary generation method in the first exemplary embodiment.

FIG. 8 is a table illustrating a format of a work result file in the first exemplary embodiment.

FIG. 9 is a sequence diagram illustrating operations of the work support system in the first exemplary embodiment.

FIG. 10 is a flow diagram illustrating operations of the work support system according to the first exemplary embodiment.

FIG. 11 is a block diagram illustrating a configuration of a work support system according to a second exemplary embodiment.

FIG. 12 is a table illustrating a format of a work slip in the second exemplary embodiment.

FIG. 13 is a table illustrating a format of a work slip in a third exemplary embodiment.

FIG. 14 includes tables each illustrating a format of a work slip in the third exemplary embodiment.

FIG. 15 is a block diagram illustrating a configuration of a work support system according to a fourth exemplary embodiment.

FIG. 16 is a diagram illustrating data held by a management server and a portable terminal in the work support system according to the fourth exemplary embodiment.

FIG. 17 is a sequence diagram illustrating operations of the work support system according to the fourth exemplary embodiment.

FIG. 18 is a diagram illustrating data held by a management server and a portable terminal in a work support system according to a fifth embodiment.

FIG. 19 is a sequence diagram illustrating operations of the work support system according to the fifth exemplary embodiment.

### MODES

First, an overview of an exemplary embodiment of the present invention will be described. Reference numerals in the drawings given in this overview are illustrations solely for helping understanding, and do not intend to limit the present invention to modes illustrated.

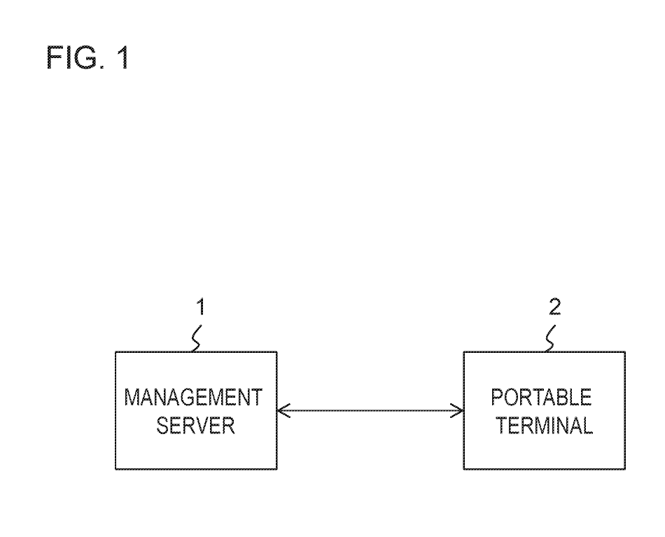

FIG. 1 is a diagram illustrating a configuration of a work support system according to the exemplary embodiment. Referring to FIG. 1, the work support system includes a management server 1 and a portable terminal 2 (such as a smartphone carried by a worker). The work support system in the present invention is a work support system for work such as assembly work, packing work, carrying work, or measuring work to be executed according to a work instruction.

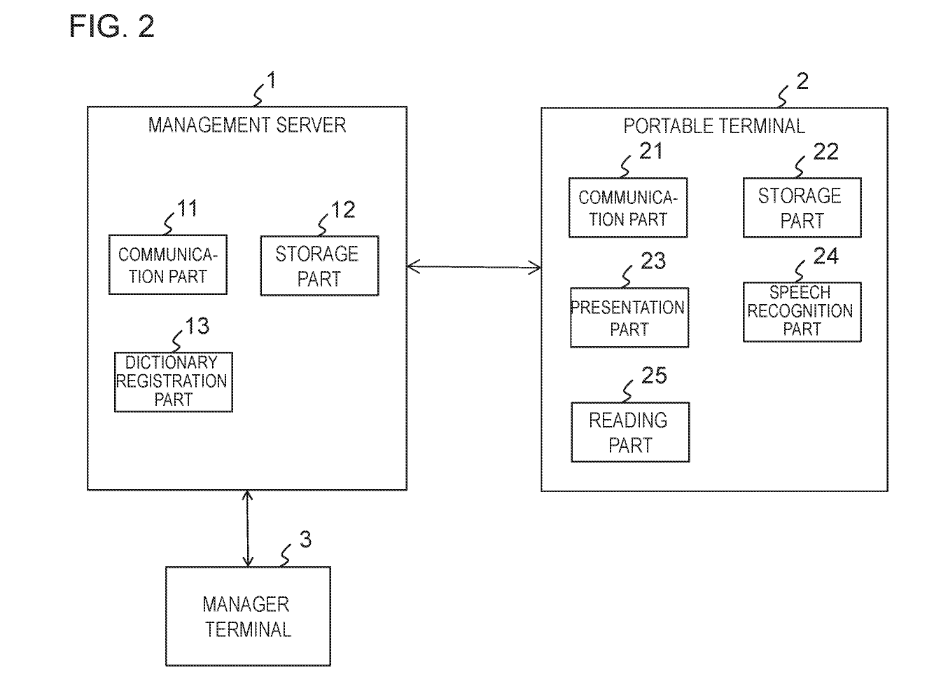

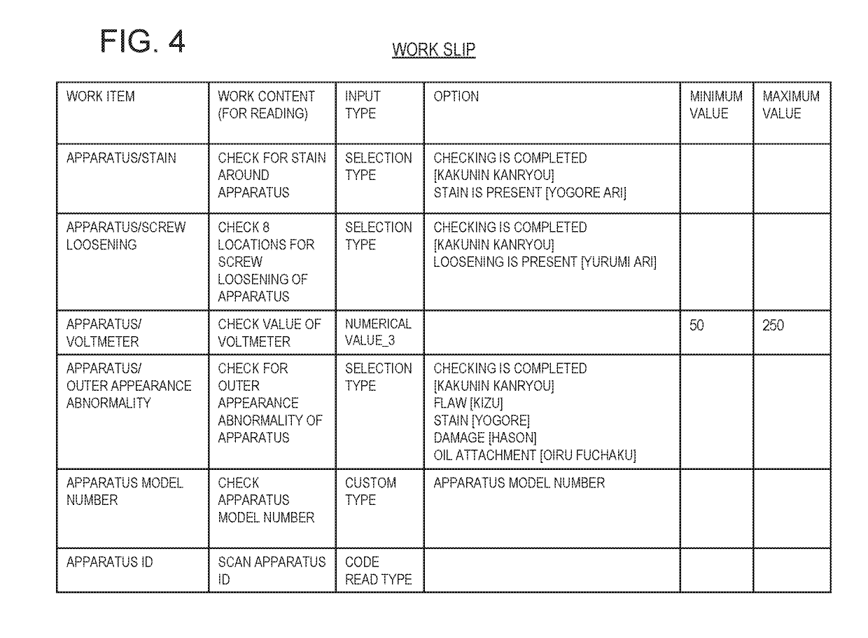

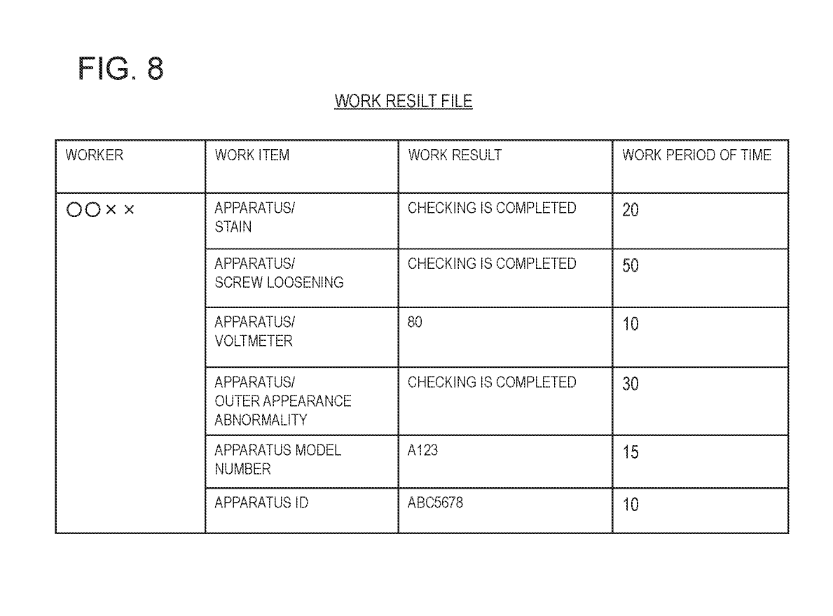

FIG. 2 is a block diagram illustrating configurations of the management server 1 and the portable terminal 2. Referring to FIG. 2, the management server 1 includes an acceptance part (such as a communication part 11) configured to accept slip information that associates and holds work item information (of a work item and work content (for reading) in FIG. 4, for example) indicating the work item and one or more work result candidates (each specified by an input type and an option in FIG. 4, for example), a dictionary registration part 13 configured to register the one or more work result candidates included in the slip information in a dictionary, in association with the work item or the slip information, a storage part 12 configured to associate and store the slip information and the dictionary, and a transmission part (such as the communication part 11) configured to transmit, (to the portable terminal 2, for example), the slip information together with the associated dictionary when the transmission part transmits the slip information. On the other hand, the portable terminal 2 includes a communication part 21 configured to obtain the slip information including the work item information indicating the work item and the dictionary associated with the slip information, a presentation part 23 configured to present (e.g., display or read) the work item information, a speech recognition part 24 configured to perform speech recognition of a speech input accepted for the work item information, using the dictionary, and a storage part 22 configured to hold (in FIG. 8, for example) a result of the speech recognition as a work result with respect to the work item information.

In the work support system according to the exemplary embodiment, the management server registers, in the dictionary (such as a speech recognition dictionary), one or more input candidates (work result candidates) whose speech inputs a worker is to perform, as one or more work results of each work item. The portable terminal performs speech recognition, using the dictionary obtained from the management server. In this case, an input candidate in the speech recognition by the portable terminal is limited to the one or more candidates (such as character strings or numerical expressions) registered in the dictionary. Thus, it becomes possible to remarkably reduce a possibility of occurrence of erroneous recognition. Accordingly, according to the work support system in the exemplary embodiment, it becomes possible to improve speech recognition performance for a speech input associated with work that is executed by a worker under high noise.

Further, in the work support system according to the exemplary embodiment, it is just enough for a field manager to register, in the management server, a slip in which a work item and one or more work result input candidates are associated, as an advance preparation before a start of the work. Thus, according to the work support system in the exemplary embodiment, just by changing description content of the slip, this system can be applied to various checking and inspection work in various industries without alteration of hardware and software configurations of the system.

### First Exemplary Embodiment

Subsequently, a work support system according to a first exemplary embodiment will be described with reference to the drawings.

### Configuration

FIG. 2 is a block diagram illustrating a configuration of the work support system according to this exemplary embodiment. Referring to FIG. 2, the work support system includes a management server 1 and a portable terminal 2. In addition, FIG. 2 also illustrates a manager terminal 3 that can access to the management server 1 in the work support system.

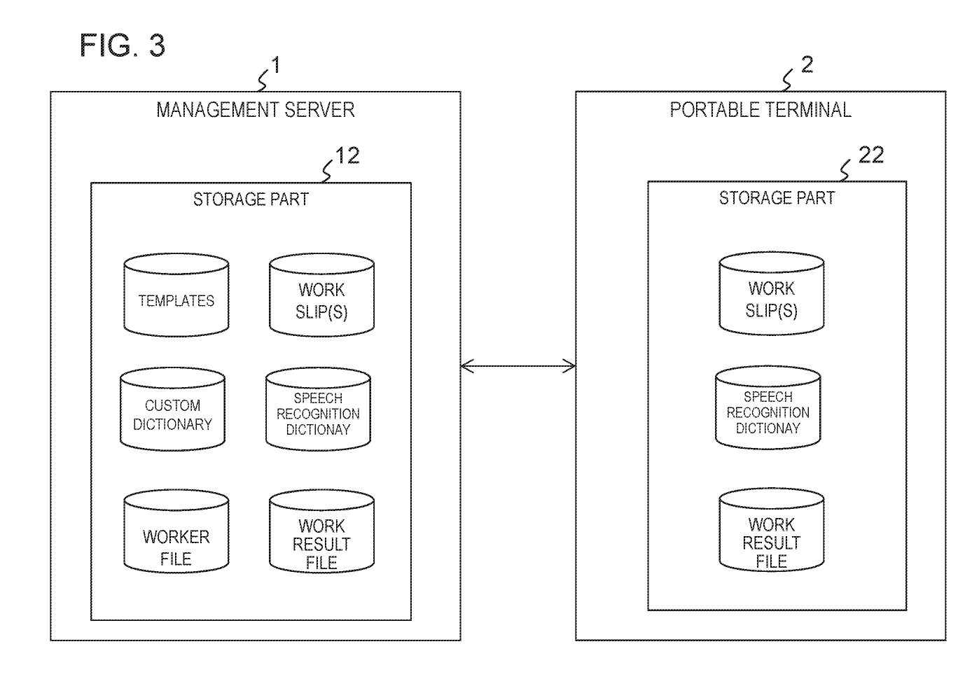

FIG. 3 is a diagram illustrating data held by the management server 1 and the portable terminal 2. Referring to FIG. 3, a storage part 12 of the management server 1 stores templates, a work slip, a custom dictionary, a speech recognition dictionary, a worker file, and a work result file. On the other hand, a storage part 22 of the portable terminal 2 stores a work slip, a speech recognition dictionary, and a work result file. Details of each of these files will be described later.

Although not shown in FIG. 2, it may also be so configured that the portable terminal 2 is connected to a headset by wire or wireless, a speech output from the portable terminal 2 is performed via a head phone of the head set, and a speech input to the portable terminal 2 is performed via a microphone of the headset.

The management server 1 accepts the work slip in which each work item and one or more work result input candidates are associated and held and registers the one or more input candidates included in the work slip in the speech recognition dictionary for speech recognition.

The portable terminal 2 is a terminal (such as a smartphone) carried by a worker who carries out checking and inspection work. The portable terminal 2 obtains the work slip and the speech recognition dictionary from the management server 1, performs speech recognition of a speech input accepted when the work item included in the work slip is executed, using the speech recognition dictionary, and holds a result of the speech recognition as a work result with respect to the work item.

The manager terminal 3 is a terminal (such as a PC (Personal Computer, personal computer)) that is operated by a manager who manages checking and inspection work. The manager terminal 3 registers the work slip to the management server 1 and refers to the work result file uploaded to the management server 1 by the portable terminal 2.

First, a detailed configuration of the management server 1 will be described. Referring to FIG. 2, the management server 1 includes a communication part 11, a storage part 12, and a dictionary registration part 13.

The communication part 11 transmits the templates of the work slit and the custom dictionary to the manager terminal 3, in response to a request of the manager terminal 3. The communication part 11 accepts, from the manager terminal 3, the work slit and the custom dictionary that have been described, and holds the accepted work slit and custom dictionary in the storage part 12 (in FIG. 3). Further, when the communication part 11 accepts registration of the worker from the portable terminal 2, the communication part 11 holds the name of the accepted worker in the storage part 12. The communication part 11 transmits the work slip and the speech recognition dictionary to the portable terminal 2. Further, when the work result file is uploaded from the portable terminal 2, the communication part 11 accumulates the accepted work result file in the storage part 12. The communication part 11 transmits the work result file to the manager terminal 3, in response to a perusal request from the manager terminal 3.

The dictionary registration part 13 registers each input candidate (specified by an input type and an option) included in the work slit, in the form of the speech recognition dictionary for speech recognition. FIG. 4 is a table illustrating a format of the work slip in this exemplary embodiment.

Referring to FIG. 4, the work slip holds each work item, work content (for reading), input type (also referred to as type information), option, minimum value and maximum value. The information held by the work slip is referred to as work slip information. The work item indicates the title of the work item included in the checking and inspection work. The work content (for reading) is read when voice guidance of the work content is performed for execution of work. The input type indicates a format in which a work result is input. It is assumed herein that, as an example, the input type is one of a selection type, a numerical value type, a custom type, or a code read type. An input phrase candidate is specified in the field of the option according to the input type. The work item and/or the work content (for reading) is referred to as “work item information”. The input phase candidate that is specified by the input type and the option is referred to as an “input candidate” (also referred to as a work result candidate). A minimum value and a maximum value of a numerical value, which are assumed when the input candidate is the numerical value, are specified in the fields of the minimum value and the maximum value.

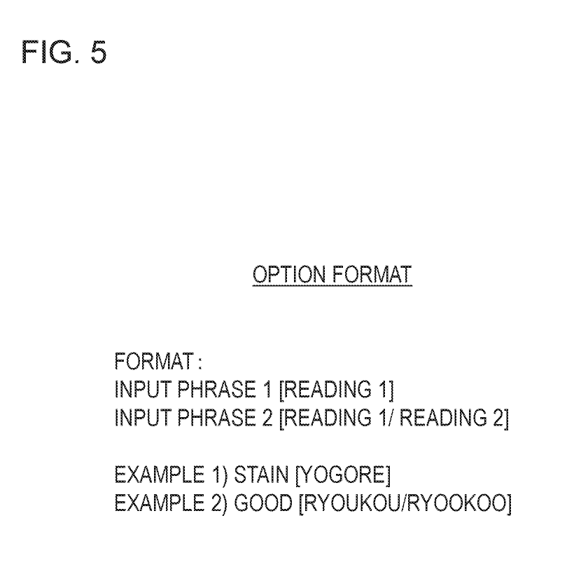

When the input type is set to the “selection type”, phrases that are input candidates and one or more readings of each phrase are specified in the field of the option. FIG. 5 illustrates an option format and an entry example. As illustrated in FIG. 5, combinations of input phases and one or more readings of each input phrase are specified in the field of the option. A plurality of readings can also be associated with one input phrase. In the disclosure of the present application including the drawings, each combination of an input phrase and the one or more readings of the input phrase is written by “Hiragana” within a bracket (H) after the input phrase. To take an example, the combination of an input phrase “Stain” and the reading of the input phrase “Stain” is written as Stain [yogore]. When a language (such as English or Chinese) having phonetic symbols is used, a reading of an input phrase can be written by a phonetic symbol. To take an example, the combination of the input phrase “Stain” and the reading of “Stain” is written as [symbol] . Alternatively, when a language like English having fixed spelling and pronunciation rules (such as in phonics) is used, it can also be so arranged that a reading of an input phrase is omitted, and using the above-mentioned rules, the reading of the input phrase is generated. When a plurality of readings are desired to be recognized in the language such as English having the phonetic symbols, a plurality of phonetic symbols can also be used. To take an example, as readings of an input phrase OK, “ [symbol] ” and “ [symbol] ” can also be written down.

This makes it possible to reduce a possibility of erroneous recognition of a speech input by the worker even when an utterance of the worker has a characteristic (e.g., the characteristic according to the age or the place of birth of the worker, a peculiarity of pronunciation of the worker, or the like) or under high noise. The dictionary registration part 13 registers, in the speech recognition dictionary, each combination of the input phrase and the (one or more) readings specified in the option.

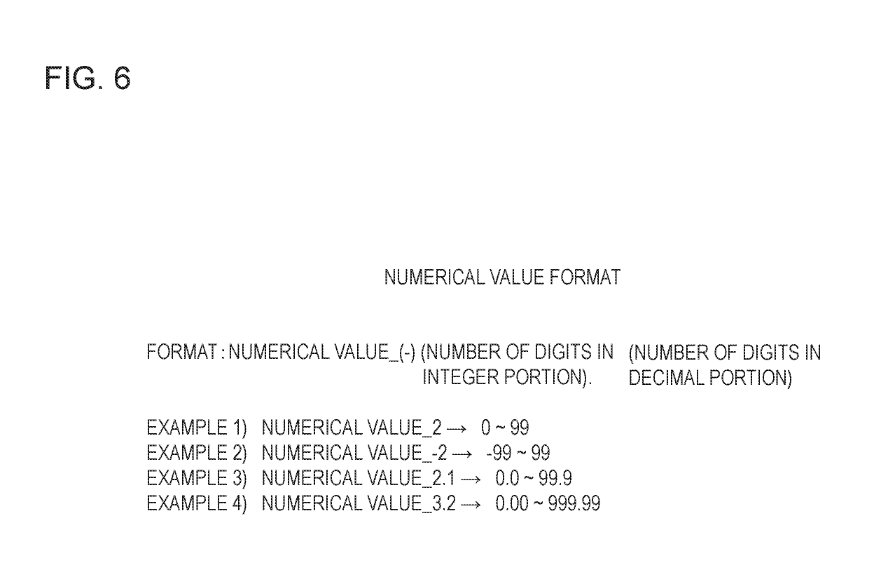

On the other hand, when the input type is set to the numerical value type, the format of a numerical value that is an input candidate is specified in the field of the input type, and the field of the option is blanked. FIG. 6 is a diagram illustrating a method of specifying the numerical value format. When “minus (−)” is specified in the numerical value format, both of a positive number and a negative number can be specified. The number of digits in an integer portion and the number of digits in a decimal portion are respectively specified in locations of the number of integer portion digits and the number of decimal portion digits. The dictionary registration part 13 registers, in the speech recognition dictionary, a pattern of reading of the numerical value in accordance with the numerical value format.

Assume that an input candidate is a numerical value. Then, if a speech recognition dictionary for a predetermined range of numerical values is to be simply generated, complex input work becomes necessary for defining the speech recognition dictionary. When a three-digit integer is an input candidate, for example, it is necessary to generate a speech recognition dictionary for readings of numerical values of all assumed patterns (all of 0 to 99) (“zero” to “kyuuhyakukyuujuukyu). According to this embodiment, however, by specifying the numerical value format in the work slip by the manager, it becomes possible to readily define the speech recognition dictionary for all patterns of numerical values each having a predetermined number of digits, a predetermined location of a decimal point, and a predetermined sign.

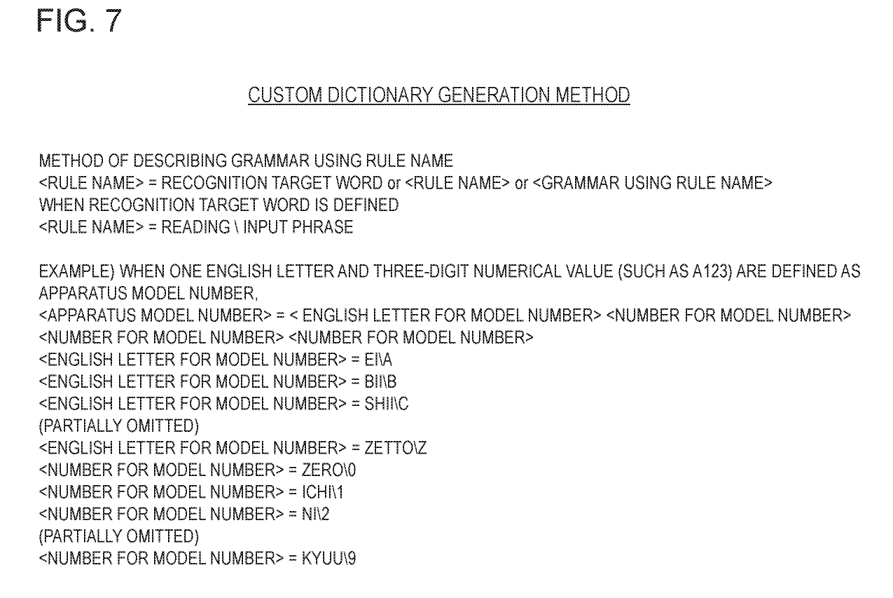

Subsequently, a description will be given about a case where the input type is the custom type. When the input type is the custom type, “custom” is specified in the field of the input type, and the name of a rule defined in the custom dictionary is described in the field of the option. FIG. 7 is a diagram for explaining a custom dictionary generation method. Using the custom dictionary, the format of an input phrase can be specified according to the rule illustrated in FIG. 7.

When an apparatus model number is composed of an English letter of one character and a three-digit numerical value, for example, it becomes possible to specify input candidate phrases (A000 to Z999) and readings of the input candidate phrases for apparatus model numbers by generating the custom dictionary illustrated in FIG. 7. In this case, for all combinations of input phrases that are generated based on the rule defined in the custom dictionary, the dictionary registration part 13 registers, in the speech recognition dictionary, the phrases and readings of the phrases.

With such an arrangement, the speech recognition dictionary can be readily generated even if an input phrase includes not only a numerical value but also includes a character and a numerical value. That is, when an input candidate is in accordance with a predetermined format (such as the model number of an apparatus or a product), it becomes possible to define the speech recognition dictionary for input candidates of all patterns just by performing little input work for the custom dictionary by the manager.

Subsequently, a detailed configuration of the portable terminal 2 will be described. Referring to FIG. 2, the portable terminal 2 includes a communication part 21, a storage part 22, a presentation part 23, a speech recognition part 24, and a reading part 25.

The communication part 21 transmits, to the management server 1, the name of the worker who carries out the checking and inspection work, using the portable terminal 2. The communication part 21 also obtains, from the management server 1, the work slip accepted from the manager terminal 3 by the management server 1 and the speech recognition dictionary generated by the management server 1, and holds the obtained work slip and the obtained speech recognition dictionary in the storage part 22. Further, the communication part 21 uploads, to the management server 1, the work result file obtained by carrying out the checking and inspection work.

As illustrated in FIG. 4, the work slip associates and holds each work item and work content indicating content of the work item. The presentation part 23 displays the name of the work item on the display of the portable terminal 2 when the work item is executed and reads (performs a speech output of) the work content indicating the content of the work item. To take an example, when the work item of “apparatus/stain” in the work slit illustrated in FIG. 4 is executed, the presentation part 23 displays the “apparatus/stain” on the display of the portable terminal 2 and performs voice guidance of “check for stain around apparatus”.

With such an arrangement, it becomes possible for the worker to grasp the work item to be executed in a hands-free state. Further, by performing voice guidance of “work content (for reading)” that specifically describes the content of work to be executed for the work item, instead of performing a speech output of the “work item” without alteration, the worker can smoothly and appropriately continue the work. This makes it possible to remarkably improve efficiency of the checking and inspection work.

The speech recognition part 24 performs speech recognition of a speech input accepted when the work item included in the work slit is executed, using the speech recognition dictionary held in the storage part 22. Further, the speech recognition part 24 records a result of the speech recognition in the storage part 22, as a work result of the work item.

To take an example, the speech recognition part 24 determines whether a speech uttered by the worker when the work item of “apparatus/stain” in the work slip illustrated in FIG. 4 is executed approximates which one of “checking is completed” and “stain is present” accumulated in the speech recognition dictionary, and determines an input phrase indicating a work result of the work item is which one of “checking is completed” and “stain is present”. When the input phrase determined by the speech recognition part 24 with respect to the work item of the “apparatus/stain” illustrated in FIG. 4 is “work is completed”, the input phase is reflected on a work result of the work result file, as illustrated in FIG. 8, and is accumulated in the storage part 22.

The presentation part 23 may notify (repeat), to the worker, the input phrase recognized by the speech recognition part 24 by voice. When the input phrase recognized by the speech recognition part 24 and the input phrase intended by the worker are different, it may be so arranged that the worker performs a predetermined operation (such as a speech input indicating that “return to the previous state” or a tap operation on the portable terminal 2) for the portable terminal 2, and the portable terminal 2 accepts (e.g., a speech input or a soft key input of) the input phrase again in response to this operation. With such an arrangement, reflection of an input phase not intended by the worker (or an input error) on the work result file can be prevented.

An operation when the portable terminal 2 accepts the input phrase manually (or by a screen touch) may be performed as follows. Specifically, when the input type is the “selection type”, the portable terminal 2 displays, at a lower portion of a checking result input screen, a pulldown menu to which a result (such as “stain is present”) is manually input, according to information on the option defined in the speech recognition dictionary. Similarly, when the input type is the “numerical value”, a “numerical value input soft key board” is automatically activated by touching the screen of the portable terminal 2. When the other input types are used, a normal “soft key board” is activated. With such an arrangement, even under a high noise environment where speech recognition is not possible or even when noise greatly increases accidentally, input of a work result can be performed seamlessly.

The reading part 25 is automatically activated when an input candidate is an identifier (identifying information) of a work target and reads the identifier. Specifically, when the input type is “code read type” as in the case of the work item of “apparatus ID” in the work slip in FIG. 4, the reading part 25 activates a camera provided in the portable terminal 2 and reads a QR code (trade mark) or a bar code given to an apparatus (or a product) to be checked and inspected.

To take an example, when an apparatus identifier read by the reading part 25 with respect to the work item of “apparatus ID” illustrated in FIG. 4 is “ABC5678”, the apparatus identifier is reflected on a work result of the work result file, as illustrated in FIG. 8, and is accumulated in the storage part 22.

When the worker carries a dedicated reading apparatus (for a bar code or the like) together with the portable terminal 2, the reading part 25 may obtain the identifier of a work target by radio communication with the reading apparatus. A method of obtaining the identifier by the reading part 25 is not limited to reading of a bar code or the like. To take an example, the reading part 25 may obtain the identifier from a tag or an IC chip attached to the target by using near field radio communication (NFC: near field radio communication).

Further, the portable terminal 2 may measure a period of time required for executing each work item by using a clocking part (not illustrated) and may associate and record the measured period of time with the work item. Referring to FIG. 8, the period of time required for executing each work item is accumulated in the work result file, in association with a worker and the work item. It can be found that in the example illustrated in FIG. 8, the work period of time of 20 seconds was required with respect to the work item of “apparatus/stain”. As mentioned above, by obtaining the work period of time for each worker and each work item and analyzing these pieces of data, study for improvement and optimization of the checking and inspection work can also be performed.

When the input type for the work item is the numerical value type, as illustrated in FIG. 4, the work slip may further hold the minimum and maximum values of the numerical value of the input candidate, in association with the work item. In this case, when an input phrase recognized by the speech recognition part 24 falls below the minimum value or exceeds the maximum value, the presentation part 23 outputs a notification (alarm) to that effect (in the form of a voice, a display, a vibration, or the like). The portable terminal 2 may accept an input phrase by a speech input, a key input, or the like, again, for example. With such an arrangement, a reading error of a measuring instrument (such as a voltmeter) or an input error by the worker can be prevented. When an abnormality occurs in the apparatus or the measuring instrument, it becomes possible to early discover the abnormality.

### Operations

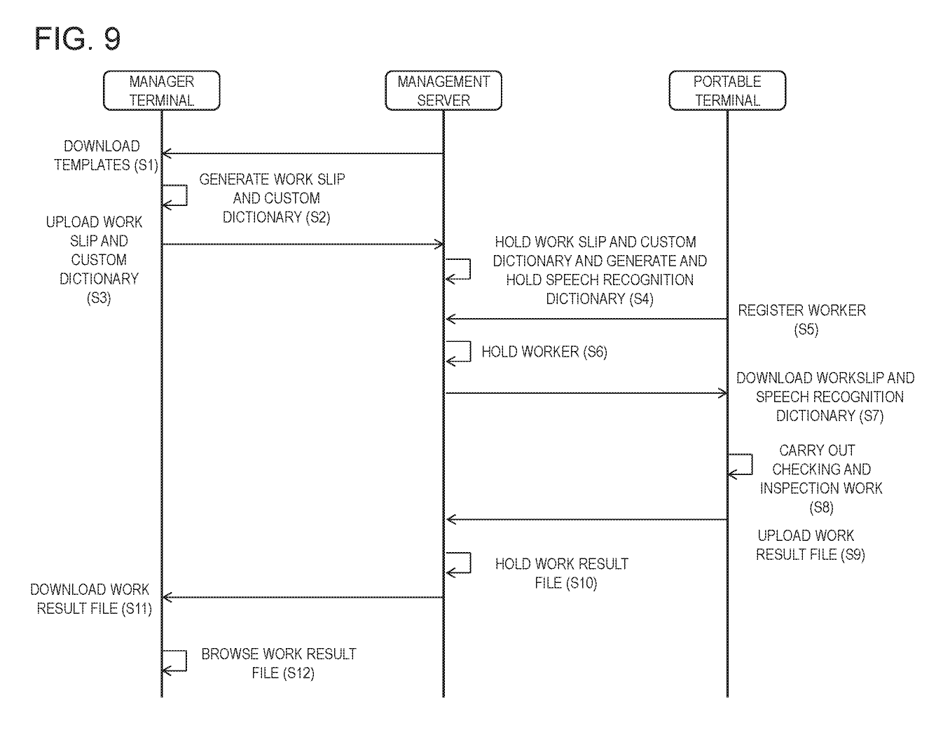

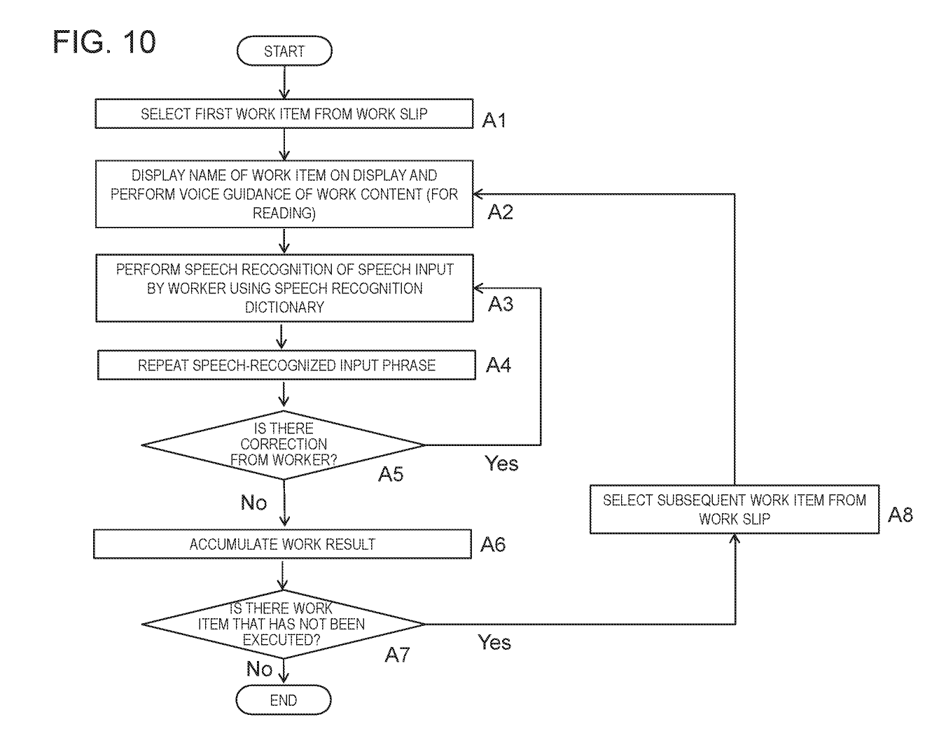

Subsequently, operations of the work support system in this exemplary embodiment will be described with reference to a sequence diagram in FIG. 9 and a flow diagram in FIG. 10.

Referring to FIG. 9, the manager terminal 3 requests a work slip template to the management server 1 and requests, to the management server 1, a custom dictionary template as necessary. The communication part 11 of the management server 1 reads these templates from the storage part 12 and transmits these templates to the manager terminal 3 (step S1). Herein, the work slip template may be the one in which content of the work slip illustrated in FIG. 4 after its second lines is blanked. The custom dictionary template may be set to a file illustrating the description example given in FIG. 7.

A manager generates a work slip using the downloaded template and generates a custom dictionary using the downloaded template as necessary (step S2). It is assumed herein that the work slit illustrated in FIG. 4 and the custom dictionary that defines the <apparatus model number> illustrated in FIG. 7 have been generated. The manager terminal 3 uploads, to the management server 1, the work slip and the custom dictionary that have been generated by the manager (step S3).

The communication part 11 of the management server 1 stores, in the storage part 12, the work slip and the custom dictionary transmitted from the manager terminal 3. Based on an input candidate (specified by an option, a numerical value format, the custom dictionary, or the like, for example) included in the work slip, the dictionary registration part 13 registers, in a speech recognition dictionary, a phrase that serves as the input candidate and a reading of the phrase (step S4).

The communication part 21 of the portable terminal 2 transmits, to the management server 1, the name of a worker who carries out checking and inspection work, using the portable terminal 2 (step S5). The communication part 11 of the management server 1 accepts registration of the worker from the portable terminal 2 and holds the accepted name of the worker in a worker file in the storage part 12 (step S6).

When the checking and inspection work is started, the communication part 21 of the portable terminal 2 obtains, from the management server 1, the work slip accepted from the manager terminal 3 by the management server 1 and the speech recognition dictionary generated by the management server 1 and holds the obtained work slip and the obtained speech recognition dictionary in the storage part 22 (step S7). In this case, it may be so arranged that the portable terminal 2 notifies the start of the work to the management server 1 and the management server 1 presents a list of work slits to the portable terminal 2 and transmits, to the portable terminal 2, one of the work slips selected by the portable terminal 2, in response to the notification of the start of the work.

Then, the field worker carries out the checking and inspection work, using the portable terminal 2 (step S8). FIG. 10 is a flow diagram illustrating operations of the portable terminal 2 when the work in FIG. 9 is carried out (step S8).

Referring to FIG. 10, in the case of the work slip illustrated in FIG. 4, the first work item of “apparatus/stain” is selected (step A1). In this case, the presentation part 23 performs voice guidance of “check for stain around apparatus” while displaying characters of “apparatus/stain” on the display of the portable terminal 2 (step A2).

It is assumed herein that the worker has observed around the apparatus, has confirmed that there is no stain, and has uttered that “confirmation is completed”, for example. Then, the speech recognition part 24 determines that the speech input uttered by the worker when the work item of “apparatus/stain” in the work slip illustrated in FIG. 4 is executed approximates “confirmation is completed” in “confirmation is completed” and “there is stain” accumulated in the speech recognition dictionary and determines that the input phrase of a work result with respect to the work item is “confirmation is completed” (step A3). Further, the presentation part repeats, to the worker, the input phrase of “confirmation is completed” recognized by the speech recognition part 24 by voice (step A4).

If a predetermined operation (such as a speech input or a tap operation) for performing correction has been performed for the portable terminal 2 from the worker (Yes in step A5), the procedure returns to step A3, and a speech input (or a text input) from the work is accepted again.

On the other hand, if the predetermined operation for performing the correction has not performed for the portable terminal 2 from the worker (No in step A5), the work result of “checking is completed” and the work period of time of “20 seconds” with respect to the work item of “apparatus/stain” are accumulated in the work result file, as illustrated in FIG. 8 (step A6).

Subsequently, the presentation part 23 determines whether a work item that has not been executed remains in the work slip (step A7). If the work item that has not been executed does not remain (No in step A7), the checking and inspection work is finished.

On the other hand, if the work item that has not been executed is present (Yes in step A7), the presentation part 23 selects a subsequent work item (such as “apparatus/screw loosening) (step A8), and performs display of the selected work item using the display and performs voice guidance of the selected work item (step A2).

By repeating the operations mentioned above, each work item included in the work slip is sequentially executed. If there is no work item that has not been executed (No in step A7), the checking and inspection work is finished. It is assumed herein that the work result file illustrated in FIG. 8 is obtained for the work slip illustrated in FIG. 4.

The description will be returned to the explanation of FIG. 9. If every work item included in the work slip is completed, the communication part 21 of the portable terminal 2 uploads the work result file (in FIG. 8) to the management server 1 (step S9 in FIG. 9). The communication part 11 of the management server 1 records, in the storage part 12, the work result file that has been received (step S10).

The manager downloads the work result file (in FIG. 8) from the management server 1, using the manager terminal 3 (step S11), and checks whether the checking and inspection work has been carried out with no problem (step S12).

### Effects

In the work support system according to this exemplary embodiment, the management server accepts, as a work slip, one or more input candidates whose speech inputs a worker is to perform as work result(s) of each work item and registers the one or more input candidates included in the accepted work slip in a speech recognition dictionary for speech recognition in advance. Further, the portable terminal performs speech recognition of a speech input by the worker, using the speech recognition dictionary obtained from the management server. With such an arrangement, input candidate narrowing is performed, thereby eliminating a possibility of picking up noise. Thus, according to this exemplary embodiment, a noticeable effect of enhancing a speech input recognition rate in a noise environment such as a factory is brought about.

That is, in this exemplary embodiment, each work item and the one or more work result input candidates are associated. Thus, control can be performed on the side of the portable terminal so that, for each work item, a limitation (or constraint) is imposed on a word (word to be recognized) that will become a target of speech recognition. Speech recognition performance is thereby improved. Further, according to this exemplary embodiment, a typical utterance variation (such as okkei (okay)/oukei (ok) meaning all right (all right)) can be defined in each input candidate. Thus, even if an utterance variation exists, a high recognition rate can be ensured.

In the work support system according to this exemplary embodiment, as an advance preparation before a start of work, a field manager or the like should only register, in the management server, a slip in which a work item and one or more work result input candidates are associated. Accordingly, the work support system mentioned above can be applied to checking and inspection work in various fields, and the work item can also be readily changed.

Further, in this exemplary embodiment, the input types such as the numerical value type and the custom type are provided. Thus, just by performing little editing work for a work slip and a custom dictionary by the manager, a speech recognition dictionary can be defined with respect to every combination of a numerical value and a character string (such as a sequence of an English letter and the numerical value) of a predetermined format.

### Variation Example of First Exemplary Embodiment

When a plurality of work items are included in a work slip in the first exemplary embodiment (see FIG. 4), the dictionary registration part 13 of the management server 1 may generate the speech recognition dictionary illustrated in FIG. 3 as a group of dictionaries for the respective work items. Specifically, when the plurality of work items are included in the work slip, the dictionary registration part 13 of the management server 1 registers one or more work result candidates associated with each work item in a dictionary for each work item. When the communication part 11 transmits the work slip to the portable terminal 2, the communication part 11 transmits the work slip together with each dictionary associated with each work item included in the work slip. On the other hand, when the plurality of work items are included in the work slip, the communication part 21 of the portable terminal 2 obtains the dictionary for each work item associated with each work item, and the speech recognition part 24 performs speech recognition of a speech input, using the dictionary for each work item. With such an arrangement, by referring to the dictionary associated with the work item at a time of the speech recognition, a recognition rate of the speech recognition can be improved.

The dictionary registration part 13 may associate and register, in the dictionary, the one or more work result candidates with the work slip, instead of associating and registering, in the dictionary, the one or more work result candidates with each work item.

The communication part 21 may download a plurality of work slips from the management server 1. In this case, it may be so arranged that the portable terminal 2 recognizes a speech utterance of the name of a work slip by using the speech recognition part 24, thereby allowing selection of a desired work slip from among the downloaded plurality of work slips.

### Second Exemplary Embodiment

Subsequently, a work support system according to a second exemplary embodiment will be described with reference to the drawings. The work support system in this exemplary embodiment determines a degree of skill of a worker (such as the degree of skill of a man skilled in the art, a beginner, or the like) for checking and inspection work, and switches guidance of work content and one or more input candidates according to the degree of skill. A difference between this exemplary embodiment and the first exemplary embodiment will be mainly described below. Herein, for simplicity, the degree of skill is set to be divided into two levels (of the beginner and the man skilled in the art). The degree of skill may be, however, set to be divided into further more levels.

### Configuration

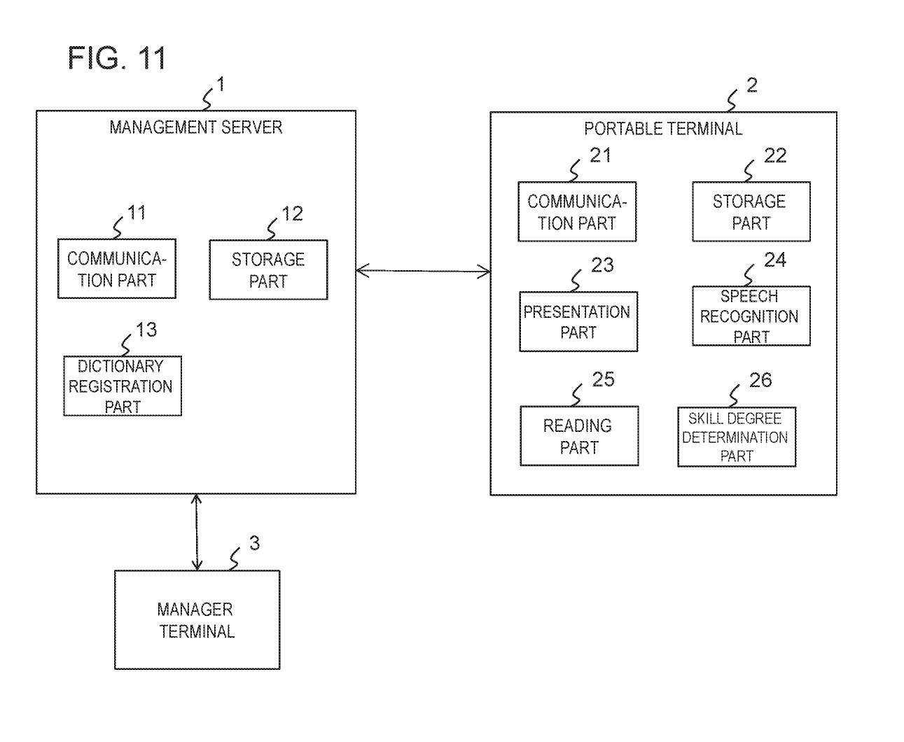

FIG. 11 is a block diagram illustrating the work support system according to this exemplary embodiment. Referring to FIG. 11, a portable terminal 2 in this exemplary embodiment is different from the portable terminal 2 (in FIG. 2) in the first exemplary embodiment in that the portable terminal 2 in this exemplary embodiment further includes a skill degree determination part 26. In this exemplary embodiment, a work slip has a different format from that in the first exemplary embodiment.

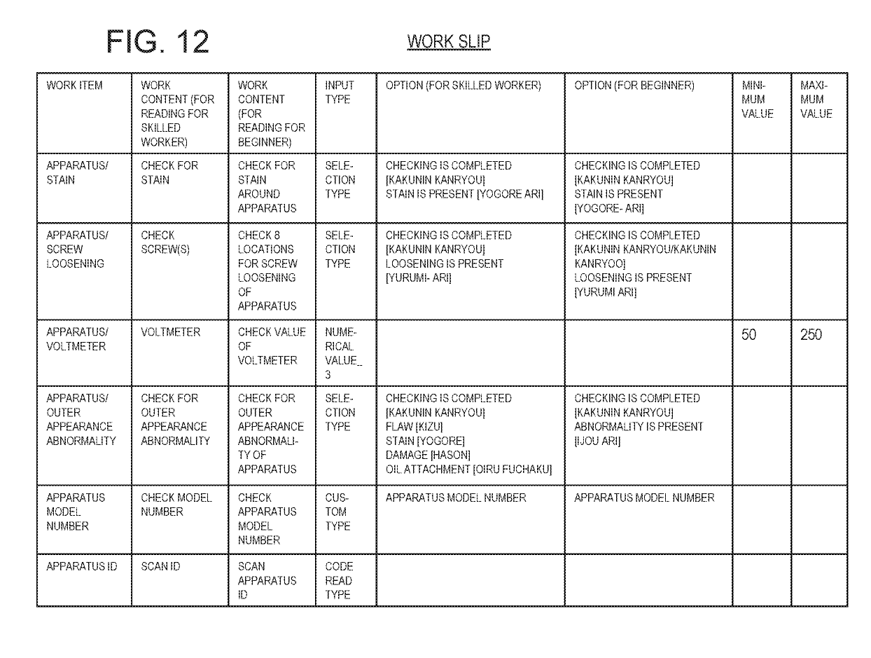

FIG. 12 illustrates the format of the work slip in this exemplary embodiment. The work slip in this exemplary embodiment includes “work content (for reading)” for each of a man skilled in the art and a beginner. The work slit in this exemplary embodiment includes an “option” for each of the man skilled in the art and the beginner. Though entry according to the degree of skill is enabled for each of the “work content (for reading)” and the “option” in the work slip in this exemplary embodiment, entry according to the degree of skill may be enabled for just one of these items.

The skill degree determination part 26 records the number of times of the checking and inspection work that have been carried out using the work slip, for each worker. When the number of times of the work by the worker using the work slip is equal to or more than a predetermined number of times, the skill degree determination part 26 determines the degree of skill of the worker to be the “man in the skill of the art”. Otherwise, the skill degree determination part 26 determines the worker to be the “beginner”. When the skill degree determination part 26 accepts specification of the degree of skill of the worker (such as an input of the degree of skill to the portable terminal 2 by the worker or registration of the degree of skill in the management server 1 and notification of the degree of skill to the portable terminal 2 by a manager), the worker may be regarded as having the specified degree of skill.

A presentation part 23 reads (performs a speech output of) work content indicating content of a work item according to a result of the determination by the skill degree determination part 26.

To take an example, assume that a work item of “apparatus/screw loosening” in the work slip illustrated in FIG. 12 is executed. Then, when the worker is the “man skilled in the art”, the presentation part 23 performs voice guidance of “check screw” while displaying “apparatus/screw loosening” on the display of the portable terminal 2. On other hand, when the worker is the “beginner” when the work item of “apparatus/screw loosening” is executed, the presentation part 23 performs voice guidance of “check eight locations for screw loosening in apparatus) while displaying “apparatus/screw loosening” on the display of the portable terminal 2.

Further, a speech recognition part 24 performs speech recognition of a speech input accepted when the work item included in the work slip is executed, based on the option specified according to the degree of skill of the worker.

To take an example, assume that a work item of “apparatus/outer appearance abnormality” in the work slip illustrated in FIG. 12 is executed. Then, when the worker is the man skilled in the art, the speech recognition part 24 determines which one of “checking is completed”, “flaw”, “stain”, “damage”, and “oil attachment” accumulated in a speech recognition dictionary the speech uttered by the worker approximates, and determines which one of “checking is completed”, “flaw”, “stain”, “damage”, and “oil attachment” the input phrase of a work result of the work item is. On the other hand, when the worker is the beginner at a time of execution of the work item of “apparatus/outer appearance abnormality”, the speech recognition part 24 determines which one of “checking is completed” and “abnormality is present” accumulated in the speech recognition dictionary the speech uttered by the worker approximates and determines which one of “checking is completed” and “abnormality is present” the input phrase of the work result of the work item is.

### Operations

Operations of the work support system in this exemplary embodiment are different from those in the first exemplary embodiment in that the skill degree determination part 26 of the portable terminal 2 determines the degree of skill of the worker when the work is carried out (step S8 in FIG. 9) and voice guidance of work content (step A2 in FIG. 10) and speech recognition (step A3 in FIG. 10) are performed according to a result of the determination. The other operations in this exemplary embodiment are, however, similar to those in the first exemplary embodiment.

### Effects

In this exemplary embodiment, it has been so arranged that the degree of skill of the worker is determined, and the voice guidance of the work content and the speech input of the work result are performed according to the determined degree of skill. With such an arrangement, the work content can be guided to the man skilled in the art, using a relatively short (brief) message, thereby enabling further improvement in efficiency of the work by the man skilled in the art. On the other hand, more detailed work content is guided to the beginner, thereby enabling prevention of an error in a work procedure.

Further, by providing the option for one or more input candidates according to the degree of skill of the worker, it can also be so arranged that a rough work result is obtained from the checking and inspection work by the beginner, and a detailed work result is obtained from the checking and inspection work by the man skilled in the art.

### Variation Example of Second Exemplary Embodiment

The following variation is possible with respect to the second exemplary embodiment. Specifically, the skill degree determination part 26 may determine the degree of skill of a worker for each work item instead of determining the degree of skill for each work slip. In this case, preferably, the presentation part changes instruction content for reading or presentation content of a work instruction using an image or a moving image, based on the determined degree of skill. Alternatively, the skill degree determination part 26 may determine the degree of skill of each worker with respect to a same work item by comparing work periods of time for the same work item executed by a plurality of workers. The skill degree determination part 26 may further present the determined degree of skill to the worker.

The portable terminal 2 may include a fatigue degree determination part configured to determine (and further display) a worker to be in a state of fatigue when the number of times that a work period of time of the worker exceeds a standard period of time set for each work item (or the standard period of time that is required for the worker to execute the work item) becomes equal to or higher than a predetermined threshold value. The work period time of the worker fulfilled (or was less than) the standard period of time in the past (e.g., on another work day).

The skill degree determination part 26 may measure the mean value of work periods of time required for a same work item, may compare the measured mean value and the work period time of the worker, and then may determine the degree of skill of the worker.

Alternatively, it may be so arranged that, by allowing feedback of a difference between a work period of time for each work item and the standard period of time for each work item to the portable terminal 2 of the worker, attention of the worker is prompted. Specifically, prompting of the attention of the worker can be implemented in the following way. That is, the portable terminal 2 measures and holds a measured value of the work period of time. A column of the standard periods of time for the respective work items is provided in the work slip (in FIG. 4). Further, the difference between the measured value of the work period of time and the standard period of time is computed by the portable terminal 2 or is computed by a management server 1 always connected to the portable terminal 2, and the result of the computation is returned to the portable terminal 2. When the measured value of the work period of time and the standard period of time is equal to or higher than a threshold value, the portable terminal 2 may perform predetermined display (in a red color or the like, for example) or may output an alert such as a beep sound, thereby prompting the attention of the worker.

### Third Exemplary Embodiment

Subsequently, a work support system according to a third exemplary embodiment will be described with reference to the drawings. The work support system in this exemplary embodiment enables switching (conditional branching) of a work item to be subsequently executed during checking and inspection, according to a work result. A description will be given below, centering on a difference between this exemplary embodiment and the first exemplary embodiment.

### Configuration

A configuration of the work support system in this exemplary embodiment is the same as that (in FIG. 2) of the work support system in the first exemplary embodiment. However, the function of a presentation part 23 and the format of a work slip in this exemplary embodiment are different from those in the first exemplary embodiment.

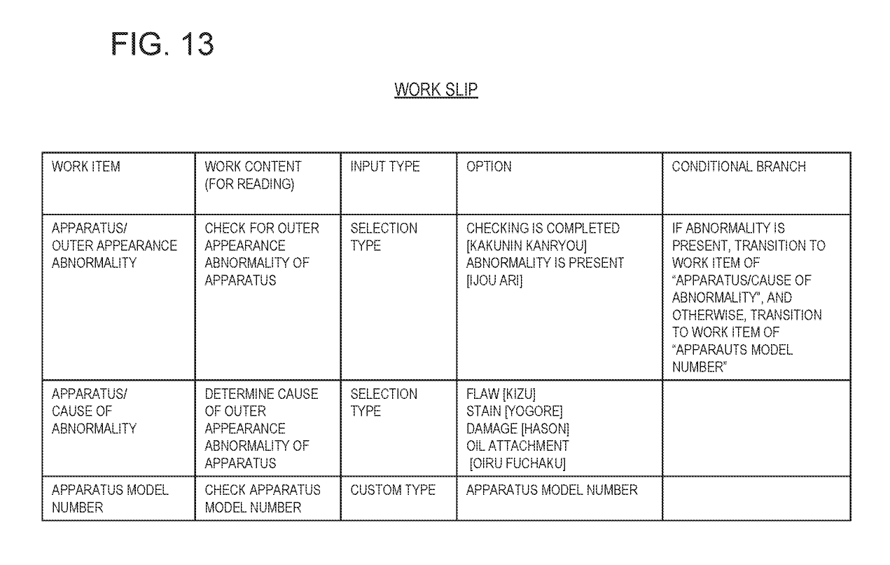

FIG. 13 is a table illustrating a configuration of the work slip in this exemplary embodiment. Referring to FIG. 13, the work slip has a field of “conditional branch” and associates and holds a first work item and a second work item to be executed subsequent to the first work item according to a work result of the first work item.

In the work slip illustrated in FIG. 13, when a speech input as a work result of a work item of “apparatus/outer appearance abnormality” is speech-recognized to be “abnormality is present”, the presentation part 23 selects a work item of “apparatus/cause of abnormality of” as a work item to be subsequently executed. That is, the presentation part 23 performs voice guidance of “determine cause of outer appearance abnormality of apparatus” while displaying “apparatus/cause of abnormality” on the display of a portable terminal 2.

On the other hand, when the speech input as the work result of the work item of “apparatus/outer appearance abnormality” is speech-recognized to be “checking is completed”, the presentation part 23 selects a work item of “apparatus model number” as a work item to be subsequently executed. That is, the presentation part 23 skips the work item of “apparatus/cause of abnormality”, and displays the work item of “apparatus model number” on the display of the portable terminal 2 and simultaneously performs voice guidance of “check apparatus model number”.

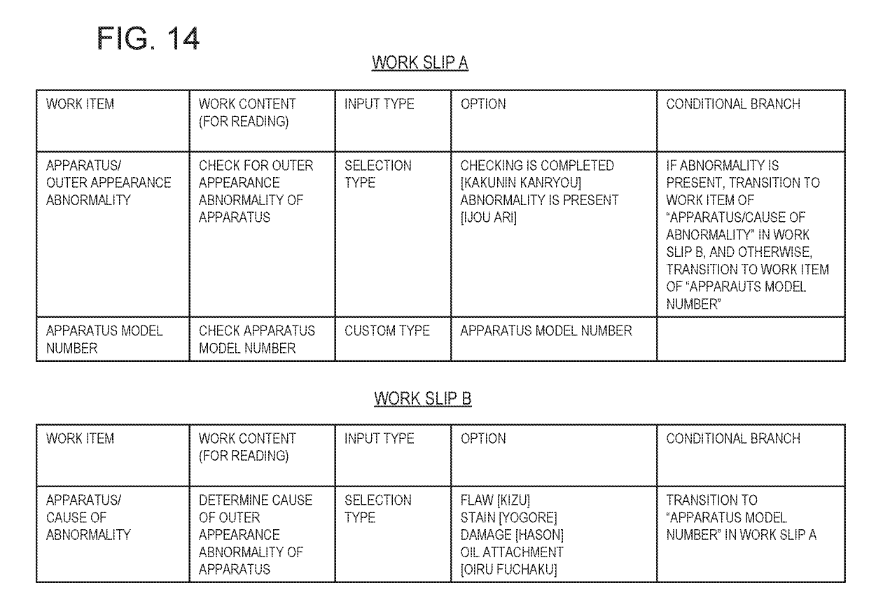

In the slip illustrated in FIG. 13, a work item of a transition destination (branch destination) according to a work result is described in the same work slip. On the other hand, the work item of the transition destination (branch destination) may be a work item described in a different work slip, as illustrated in FIG. 14. When a work result of a work item of “apparatus/outer appearance abnormality” in a work slip A is “abnormality is present”, the presentation part 23 selects, as a work item to be subsequently executed, a work item of “apparatus/cause of abnormality” in a work slip B, in the work slips illustrated in FIG. 14. Further, when the work item of “apparatus/cause of abnormality” in the work slip B is finished, the presentation part 23 selects a work item of “apparatus model number” in the work slip A, as a work item to be subsequently executed.

### Operations

Operations of the work support system in this exemplary embodiment are different from those in the first exemplary embodiment in that at a time of work execution (step S8 in FIG. 9), the presentation part 23 transitions to a work item to be subsequently executed according to a condition described in the field of conditional branch in the work slip. The other operations, however, are the same as those in the first exemplary embodiment.

### Effect

According to this exemplary embodiment, it becomes possible to flexibly switch a work item to be subsequently executed, according to a work result of a work item during checking and inspection work. Accordingly, depending on the work result, the work can be carried out by omitting a work item that can be omitted, so that it becomes possible to efficiently carry out the checking and inspection work. Further, according to this exemplary embodiment, a plurality of work slips can be switched according to a work result. With such an arrangement, work items can be classified according to work content and can be separated and managed in the plurality of work slips, so that generation and management of the work slips by a manager are facilitated.

### Fourth Exemplary Embodiment

Subsequently, a work support system according to a fourth exemplary embodiment will be described with reference to the drawings. In the work support system in this exemplary embodiment, an utterance feature of a worker is learned in advance, and a recognition rate of a speech input by the worker is thereby further improved. A description will be given below, centering on a difference between this exemplary embodiment and the first exemplary embodiment.

### Configuration

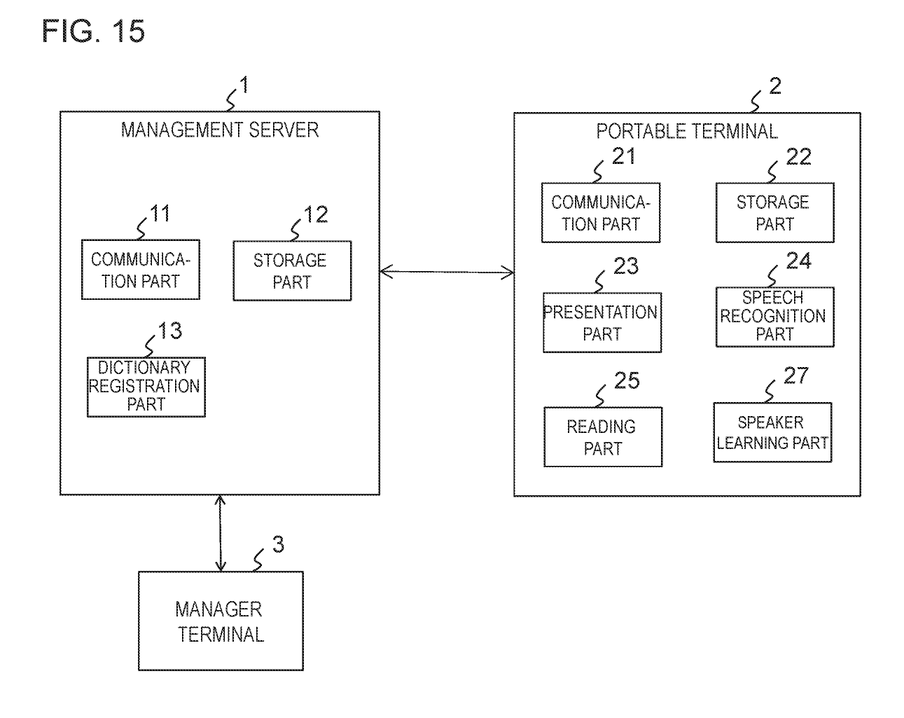

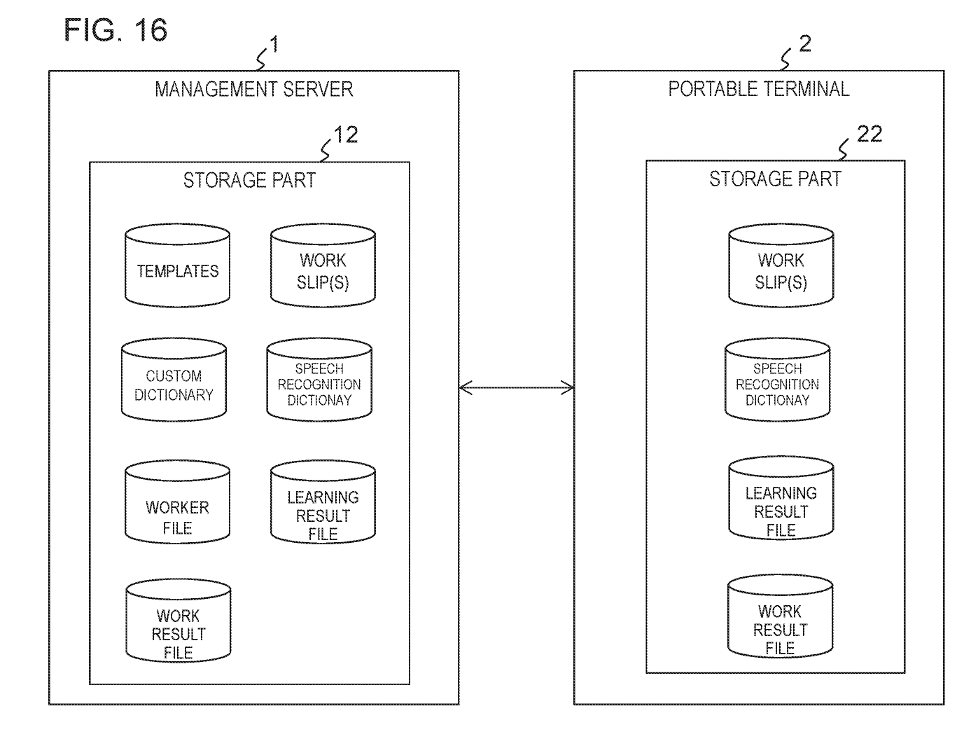

FIG. 15 is a block diagram illustrating a configuration of the work support system according to this exemplary embodiment. Referring to FIG. 15, a portable terminal 2 in this exemplary embodiment is different from that in the first exemplary embodiment in that the portable terminal 2 in this exemplary embodiment further includes a speaker learning part 27. FIG. 16 is a diagram illustrating data held by a management server 1 and the portable terminal 2 in the work support system according to this exemplary embodiment. Referring to FIG. 16, the management server 1 and the portable terminal 2 in this exemplary embodiment are different from those in the first exemplary embodiment in that each of the management server 1 and the portable terminal 2 in this exemplary embodiment further holds a learning result file indicating a result of leaning of the feature of an utterance by the worker.

The speaker learning part 27 presents a plurality (approximately 50, as an example) of words and readings of the words and instructs the worker to read the presented words. The speaker learning part 27 learns the utterance feature of the worker by a method of causing the worker to repeat an utterance until a speech uttered by the worker can be correctly recognized. After the learning is completed, a communication part 21 uploads, to the management server 1, the learning result file in which a result of the leaning and the name of the worker are associated. A communication part 11 of the management server 1 records, in a storage part 12 (in FIG. 16), the learning result file that has been received.

In this exemplary embodiment, the communication part 21 of the portable terminal 2 downloads, from the management server 1, the learning result file associated with the worker and holds the learning result file in a storage part 22 (in FIG. 16) before checking and inspection work is started. Further, when the checking and inspection work is carried out, a speech recognition part 24 performs speech recognition of a speech input accepted when a work item is executed, using a speech recognition dictionary and the learning result file held by the storage part 22.

### Operations

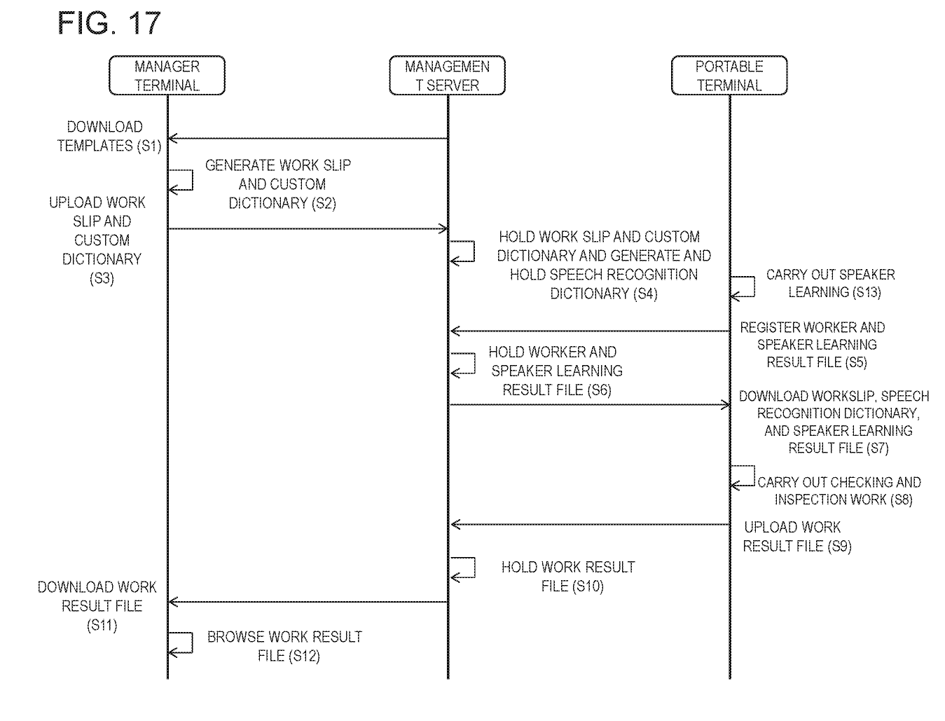

FIG. 17 is a sequence diagram illustrating operations of the work support system according to this exemplary embodiment. Herein, the difference between this exemplary embodiment and the first exemplary embodiment will be described.

In this exemplary embodiment, before checking and inspection work is carried out, the speaker learning part 27 performs speaker learning (step S13). When the communication part 21 of the portable terminal 2 transmits the name of a worker to the management server 1, the communication part 21 transmits a learning result file as well (step S5). The communication part 11 of the management server 1 accepts registration of the name of the worker and the learning result file from the portable terminal 2, and holds, in the storage part 12, the name of the worker and the learning result file that have been accepted (step S6).

Before the checking and inspection work is started, the communication part 21 of the portable terminal 2 obtains, together with a work slip and a speech recognition dictionary, the learning result file from the management server 1, and holds, in the storage part 22, the work slip, the speech recognition dictionary, and the learning result file that have been obtained (step S7).

When speech recognition (step A3 in FIG. 10) included in the checking and inspection work (step S8) is performed, the speech recognition part 24 performs speech recognition of a speech input by the worker using not only the speech recognition dictionary but also the learning result file held by the storage part 22.

### Effect

According to this exemplary embodiment, by performing speech recognition using not only a speech recognition dictionary based on one or more input candidates extracted from a work slip but also a learning result file obtained by learning the utterance feature of a worker in advance, a speech input as intended by the worker can be implemented with a higher recognition rate, even under high noise.

### Fifth Exemplary Embodiment

Subsequently, a work support system according to a fifth exemplary embodiment will be described with reference to the drawings. The work support system in this exemplary embodiment enables correct reading when work content is read and when a speech recognition result is repeated. A description will be given below, centering on a difference between this exemplary embodiment and the first exemplary embodiment.

### Configuration

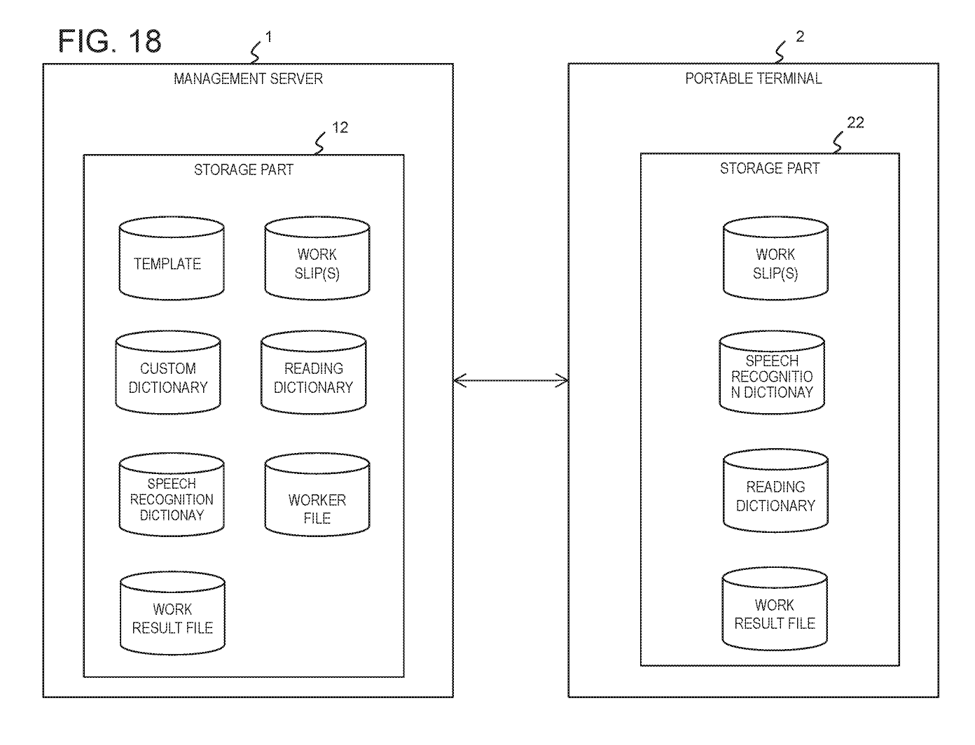

The work support system in this exemplary embodiment has the same configuration as the work support system in the first exemplary embodiment (in FIG. 2). However, data held by a management server 1 and a portable terminal 2 in this exemplary embodiment are different from those in the first exemplary embodiment. FIG. 18 is a diagram illustrating the data held by the management server 1 and the portable terminal 2 in the work support system according to this exemplary embodiment. Referring to FIG. 18, the management server 1 and the portable terminal 2 in this exemplary embodiment are different from those in the first exemplary embodiment in that each of the management server 1 and the portable terminal 2 further includes a reading dictionary in which each word and the reading of the word are associated.

Preferably, phrases such as a difficult phrase, a technical term, a jargon, and an in-house jargon and readings of the phrases in particular are registered in the reading dictionary. Further, a phrase that has not been correctly read and the reading of the phrase when work content (for reading) is read and when a speech recognition result is repeated may be registered in the reading dictionary at any time.

In this exemplary embodiment, a communication part 11 of the management server 1 transmits templates of a work slip, a custom dictionary, and the reading dictionary to a manager terminal 3, in response to a request of the manager terminal 3. Further, the communication part 11 accepts, from the manager terminal 3, the work slip, the custom dictionary, and the reading dictionary that have been described and holds, in a storage part 12 (in FIG. 18), the work slip, the custom dictionary, and the reading dictionary that have been accepted.

In this exemplary embodiment, a communication part 21 of the portable terminal 2 downloads, from the management server 1, the reading dictionary together with the work slip and a speech recognition dictionary and holds the reading dictionary, the work slip, and the speech recognition dictionary in a storage part 22 (in FIG. 18). When a presentation part 23 reads work content while displaying a work item on a display, the presentation part 23 performs the reading by referring to the reading dictionary. Also when the presentation part 23 repeats an input phrase recognized by a speech recognition part 24, the presentation part 23 performs reading by referring to the reading of the input phrase registered in the reading dictionary.

### Operations

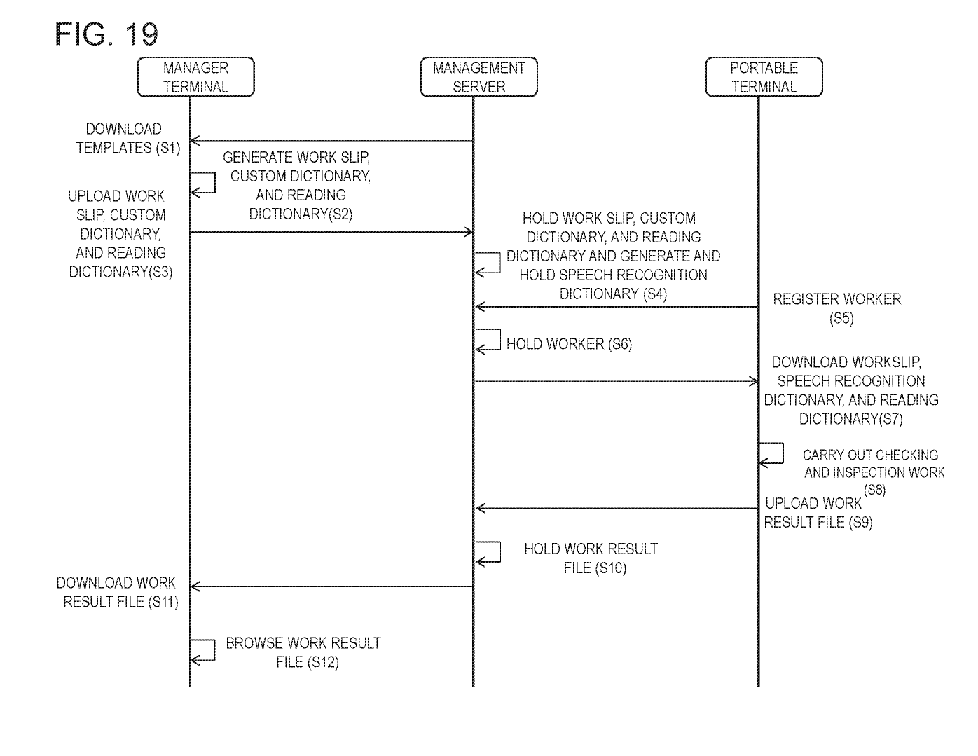

FIG. 19 is a sequence diagram illustrating operations of the work support system according to this exemplary embodiment. Herein, a description will be given, centering on a difference between this exemplary embodiment and the first exemplary embodiment.

Referring to FIG. 19, the manager terminal 3 downloads, from the management server 1, a reading dictionary template together with template(s) of a work slip (and a custom dictionary as necessary) (step S1). The reading dictionary template may be set to a file illustrating a phrase and a method of defining the reading of the phrase, for example.

A manager generates the work slip, the custom dictionary, and a reading dictionary, using the downloaded templates (step S2). The manager terminal 3 uploads the work slip, the custom dictionary, and the reading dictionary generated by the manager to the management server 1 (step S3). The communication part 11 of the management server 1 stores, in the storage part 12, the work slip, the custom dictionary, and the reading dictionary transmitted from the manager terminal 3 (step S4).

Before checking and operating work is started, the communication part 21 of the portable terminal 2 obtains, from the management server 1, the reading dictionary together with the work slip and a speech recognition dictionary, and stores, in the storage part 22, the work slip, the speech recognition dictionary, and the reading dictionary that have been obtained (step S7).

When the checking and inspection work is carried out (step S8), the presentation part 23 performs reading of work content by referring to the reading dictionary at a time of reading of the work content while displaying a work item on the display (step A2 in FIG. 10). Further, when the presentation part 23 repeats an input phrase recognized by the speech recognition part 24, the presentation part 23 performs reading, based on the reading of the phrase registered in the reading dictionary (step A4 in FIG. 10).

### Effect

According to this exemplary embodiment, even when a technical term or the like is included in work content or an option for an input candidate, voice guidance and repetition can be performed according to the correct reading. It thereby becomes possible to smoothly perform checking and inspection work without confusing a worker by an erroneous reading, or without suspending the work.

### Variation Example

Various variations are possible with respect to the above-mentioned exemplary embodiments. To take an example, each work item and an image (still image) or a moving image of an apparatus (or a product) that is set to a target of work in the work item may be associated and held in the work slip illustrated in FIG. 4. In this case, when the work item is executed, the presentation part 23 displays, together with the name of the work item, the image or the moving image of the target apparatus (or the target product) associated with the work item on the display of the portable terminal 2 (step A2 in FIG. 10). Preferably, along with reading of work content indicating the content of the work item, the presentation part 23 notifies, to the worker, that the image or the moving image of the target apparatus (or the target product) is being displayed, by voice (step A2 in FIG. 10).

According to the variation example mentioned above, the worker can readily grasp the apparatus (or the product) that should be the target of checking and inspection in each work item and can thereby carry out the work quickly and correctly.

The following modes of the present invention are possible.

### First Mode

See the management server according to the first aspect.

### Second Mode

The management server preferably according to the first mode, wherein the work result candidate(s) includes type information indicating at least a type of a work result, and the type information indicates that the type of the work result is any one of at least a character string type, a numerical value type, a custom type, or a read type.

### Third Mode

The management server preferably according to the second mode, wherein
the acceptance part accepts the slip information that holds the work result candidate(s) including the type information indicating that the type is the character string type, a character string, and reading information of the character string indicating one or more readings of the character string; and
the dictionary registration part registers, in the dictionary, the reading information indicating the one or more readings of the character string, in association with the character string.

### Fourth Mode

The management server preferably according to any one of the first to third modes, wherein
the acceptance part accepts the slip information that holds the work result candidate(s) including the type information indicating that the type is the numerical value type and a format of the numerical value; and
the dictionary registration part registers, in the dictionary, reading information of the numerical value, in association with the format of the numerical value.

### Fifth Mode

The management server preferably according to any one of the first to fourth modes, wherein
the acceptance part accepts the slip information that holds the work result candidate(s) including the type information indicating that the type is the custom type and a rule name when a character string is defined by a predetermined rule and accepts a file that associates and holds the rule name and the definition of the character string based on the predetermined rule; and
the dictionary registration part registers, in the dictionary, reading information of the character string based on the predetermined rule, in association with the rule name.

### Sixth Mode

The management server preferably according to any one of the first to fifth modes, wherein
when a plurality of pieces of the work item information are included in the slip information, the dictionary registration part registers, in dictionaries for the respective pieces of the work item information, the one or more work result candidates associated with the respective pieces of the work item information; and
when the transmission part transmits the slip information, the transmission part transmits the slip information together with the respective dictionaries associated with the respective pieces of the work item information included in the slip information.

### Seventh Mode

The management server preferably according to any one of the first to sixth modes, wherein
the transmission part transmits the slip information and the dictionary associated with the slip information to a portable terminal; and
the portable terminal performs speech recognition of a speech input accepted for the work item information, using the dictionary, and holds a result of the speech recognition as a work result with respect to the work item information.

### Eighth Mode

The management server preferably according to the seventh mode, wherein
when the type information included in the work result candidate indicates the read type, the portable terminal holds information accepted via reading means for reading identification information of a work target, as the work result with respect to the work item information.

### Ninth Mode

The management server preferably according to the seventh or eighth mode, wherein
the work item information associates and holds a name of the work item and information indicating content of the work item; and
the portable terminal displays the name of the work item and reads the information indicating the content of the work item.

### Tenth Mode

The management server preferably according to any one of the seventh to ninth modes, wherein
the portable terminal records a period of time required from presentation of the work item information to completion of the speech recognition, in association with the work item information.

### Eleventh Mode

The management server preferably according to any one of the seventh to tenth modes, wherein
the acceptance part accepts the slip information that holds the work item information and/or the work result candidate(s) based on a degree of skill of a worker;
the dictionary registration part registers, in the dictionary, the work result candidate(s) based on the degree of skill included in the slip information, in association with the work item; and
the portable terminal presents the work item information according to the degree of skill of the worker, and/or performs the speech recognition, using the work result candidate(s) associated with the degree of skill of the worker and registered in the dictionary.

### Twelfth Mode

The management server preferably according to the eleventh mode, wherein
the portable terminal holds a number of times of work executed by the worker using the slip information, determines the degree of skill of the worker based on the number of times of the work, and performs the presentation of the work item information and/or the speech recognition, using the determined degree of skill of the worker.

### Thirteenth Mode

The management server preferably according to any one of the seventh to twelfth modes, wherein
the acceptance part accepts slip information that associates and holds first work item information indicating a first work item and second work item information indicating a second work item to be executed subsequent to the first work item according to a work result of the first work item; and
the portable terminal selects the second work item according to a result of speech information of a speech input accepted for the first work item information.

### Fourteenth Mode

The management server preferably according to the thirteenth mode, wherein
the acceptance part accepts the first slip information that associates and holds the first work item information and the second work item information and second slip information that holds the second work item information; and
the portable terminal selects the second work item from the second slip information, according to the result of the speech recognition of the speech input accepted for the first work item information.

### Fifteenth Mode

See the portable terminal according to the second aspect.

### Sixteenth Mode

The portable terminal preferably according to the fifteenth mode, wherein
when a plurality of pieces of the work item information are included in the slip information and when the communication part obtains the slip information, the communication part obtains a dictionary for each work item associated with each piece of the work item information; and
the speech recognition part performs speech recognition of the speech input, using the dictionary for each work item.

### Seventeenth Mode

The portable terminal preferably according to the fifteenth mode, wherein
the communication part accepts the slip information that associates and holds the work item information indicating the work item and a work result candidate(s), and registers, in the dictionary, the work result candidate(s) included in the slip information, in association with the work item or the slip information, and obtains, from a management server configured to associate and store the slip information and the dictionary, the slip information and the dictionary associated with the slip information.

### Eighteenth Mode

The portable terminal preferably according to the seventeenth mode, wherein
the work result candidate(s) includes type information indicating at least a type of a work result and the type information indicates that the type of the work result is any one of at least a character string type, a numerical value type, a custom type, or a read type.

### Nineteenth Mode

The portable terminal preferably according to the eighteenth mode, comprising:
reading means for reading identification information of a work target when the type information included in the work result candidate indicates the read type;
wherein the storage part holds information accepted via the reading means, as the work result with respect to the work item information.

### Twentieth Mode

The portable terminal preferably according to any one of the sixteenth to nineteenth modes, wherein
the work item information associates and holds a name of the work item and information indicating content of the work item; and
the presentation part displays the name of the work item and reads the information indicating the content of the work item.

### Twenty-First Mode

The portable terminal preferably according to any one of the sixteenth to twentieth modes, wherein
the storage part records a period of time required from the presentation of the work item information to completion of the speech recognition, in association with the work item information.

### Twenty-Second Mode

The portable terminal preferably according to the eighteenth mode, wherein
when the speech recognition fails, the one or more work result candidates are displayed, and the storage part holds the work result selected from among the displayed one or more work result candidates, as the work result with respect to the work item information.

### Twenty-Third Mode

The portable terminal preferably according to the seventeenth mode, wherein
the communication part obtains a plurality of pieces of the slip information from the management server; and
the speech recognition part recognizes a speech utterance with respect to a name of at least one of the plurality of pieces of the slip information.

### Twenty-Fourth Mode

The portable terminal preferably according to the fifteenth mode, wherein
the slip information associates and holds the work item information and a still image or a moving image of a work target; and
the presentation part displays the still image or the moving image together with the work item information.

### Twenty-Fifth Mode

A work support system comprising:
the management server according to any one of the first to fourteenth modes; and
the portable terminal according to any one of the fifteenth to twenty-fourth modes.

### Twenty-Sixth Mode

See the work support method according to the fourth aspect.

### Twenty-Seventh Mode

See the work support method according to the fifth aspect.

### Twenty-Eighth Mode

See the program according to the sixth aspect.

### Twenty-Ninth Mode

See the program according to the seventh aspect.

The disclosure of the above-listed Patent Literatures is incorporated herein in its entirety by reference. Modification and adjustment of each exemplary embodiment are possible within the scope of the overall disclosure (including the claims) of the present invention and based on the technical concept of the present invention. Various combinations and selections of various disclosed elements (including each element in each claim, each element in each exemplary embodiment, and each element in each drawing) are possible within the scope of the overall disclosure of the present invention. That is, the present invention naturally includes various variations and modifications that could be made by those skilled in the art according to the overall disclosure including the claims and the technical concept. With respect to a numerical value range described herein in particular, an arbitrary numerical value and a small range included in the numerical value range should be construed to be specifically described even unless otherwise explicitly described.

### REFERENCE SIGNS LIST

1 management server
2 portable terminal
3 manager terminal
11 communication part
12 storage part
13 dictionary registration part
21 communication part
22 storage part
23 presentation part
24 speech recognition part
25 reading part
26 skill degree determination part
27 speaker learning part

What is claimed is:

1. A management server, comprising:
at least one processor configured to execute:
an acceptance part accepting slip information that associates and holds work item information indicating a work item and a work result candidate(s);
a dictionary registration part registering the work result candidate(s) included in the slip information in a dictionary, in association with the work item or the slip information;
a storage part associating and storing the slip information and the dictionary; and
a transmission part transmitting the slip information together with the associated dictionary when the transmission part transmits the slip information.

2. The management server according to claim 1, wherein
the work result candidate(s) includes type information indicating at least a type of a work result and the type information indicates that the type of the work result is any one of at least a character string type, a numerical value type, a custom type, or a read type.

3. The management server according to claim 2, wherein
the acceptance part accepts the slip information that holds the work result candidate(s) including the type information indicating that the type is the character string type, a character string, and reading information of the character string indicating one or more readings of the character string; and
the dictionary registration part registers, in the dictionary, the reading information indicating the one or more readings of the character string, in association with the character string.

4. The management server according to claim 1, wherein
the acceptance part accepts the slip information that holds the work result candidate(s) including the type information indicating that the type is the numerical value type and a format of the numerical value; and
the dictionary registration part registers, in the dictionary, reading information of the numerical value, in association with the format of the numerical value.

5. The management server according to claim 1, wherein
the acceptance part accepts the slip information that holds the work result candidate(s) including the type information indicating that the type is the custom type and a rule name when a character string is defined by a predetermined rule and accepts a file that associates and holds the rule name and the definition of the character string based on the predetermined rule; and
the dictionary registration part registers, in the dictionary, reading information of the character string based on the predetermined rule, in association with the rule name.

6. The management server according to claim 1, wherein
when a plurality of pieces of the work item information are included in the slip information, the dictionary registration part registers, in dictionaries for the respective pieces of the work item information, the one or more work result candidates associated with the respective pieces of the work item information; and
when the transmission part transmits the slip information, the transmission part transmits the slip information together with the respective dictionaries associated with the respective pieces of the work item information included in the slip information.

7. The management server according to claim 1, wherein
the transmission part transmits the slip information and the dictionary associated with the slip information to a portable terminal; and
the portable terminal performs speech recognition of a speech input accepted for the work item information, using the dictionary, and holds a result of the speech recognition as a work result with respect to the work item information.

8. The management server according to claim 7, wherein
when the type information included in the work result candidate indicates the read type, the portable terminal holds information accepted via a reading part configured to read identification information of a work target, as the work result with respect to the work item information.

9. The management server according to claim 7, wherein
the work item information associates and holds a name of the work item and information indicating content of the work item; and
the portable terminal displays the name of the work item and reads the information indicating the content of the work item.

10. The management server according to claim 7, wherein
the portable terminal records a period of time required from presentation of the work item information to completion of the speech recognition, in association with the work item information.

11. The management server according to claim 7, wherein
the acceptance part accepts the slip information that holds the work item information and/or the work result candidate(s) based on a degree of skill of a worker;
the dictionary registration part registers, in the dictionary, the work result candidate(s) based on the degree of skill included in the slip information, in association with the work item; and
the portable terminal presents the work item information according to the degree of skill of the worker, and/or performs the speech recognition, using the work result candidate(s) associated with the degree of skill of the worker and registered in the dictionary.

12. The management server according to claim 11, wherein
the portable terminal holds a number of times of work executed by the worker using the slip information, determines the degree of skill of the worker based on the number of times of the work, and performs the presentation of the work item information and/or the speech recognition, using the determined degree of skill of the worker.

13. The management server according to claim 7, wherein
the acceptance part accepts slip information that associates and holds first work item information indicating a first work item and second work item information indicating a second work item to be executed subsequent to the first work item according to a work result of the first work item; and
the portable terminal selects the second work item according to a result of speech information of a speech input accepted for the first work item information.

14. The management server according to claim 13, wherein
the acceptance part accepts the first slip information that associates and holds the first work item information and the second work item information and second slip information that holds the second work item information; and
the portable terminal selects the second work item from the second slip information, according to the result of the speech recognition of the speech input accepted for the first work item information.

15. A portable terminal, comprising:
at least one processor configured to execute:
a communication part obtaining slip information including work item information indicating a work item and a dictionary associated with the slip information;
a presentation part presenting the work item information;
a speech recognition part performing speech recognition of a speech input accepted for the work item information, using the dictionary; and
a storage part holding a result of the speech recognition, as a work result with respect to the work item information.

16. The portable terminal according to claim 15, wherein
when a plurality of pieces of the work item information are included in the slip information and when the communication part obtains the slip information, the communication part obtains a dictionary for each work item associated with each piece of the work item information; and
the speech recognition part performs the speech recognition of the speech input, using the dictionary for each work item.

17. The portable terminal according to claim 15, wherein
the communication part accepts the slip information that associates and holds the work item information indicating the work item and a work result candidate(s), and registers, in the dictionary, the work result candidate(s) included in the slip information, in association with the work item or the slip information, and obtains, from a management server configured to associate and store the slip information and the dictionary, the slip information and the dictionary associated with the slip information.

18. The portable terminal according to claim 17, wherein
the work result candidate(s) includes type information indicating at least a type of a work result and the type information indicates that the type of the work result is any one of at least a character string type, a numerical value type, a custom type, or a read type.

19. The portable terminal according to claim 18, comprising:
a reading part configured to read identification information of a work target when the type information included in the work result candidate indicates the read type;
wherein the storage part holds information accepted via the reading part, as the work result with respect to the work item information.

20. The portable terminal according to claim 16, wherein
the work item information associates and holds a name of the work item and information indicating content of the work item; and
the presentation part displays the name of the work item and reads the information indicating the content of the work item.

21. The portable terminal according to claim 16, wherein
the storage part records a period of time required from the presentation of the work item information to completion of the speech recognition, in association with the work item information.

22. (canceled)

23. A work support method comprising, by a management server:
accepting slip information that associates and holds work item information indicating a work item and a work result candidate(s);
registering the work result candidate(s) included in the slip information in a dictionary, in association with the work item or the slip information;
associating and storing the slip information and the dictionary; and
transmitting the slip information together with the associated dictionary when transmitting the slip information.

24. A work support method comprising, by a portable terminal:
obtaining slip information including work item information indicating a work item and a dictionary associated with the slip information;
presenting the work item information;
performing speech recognition of a speech input accepted for the work item information, using the dictionary; and
holding a result of the speech recognition, as a work result with respect to the work item information.

25. A non-transitory computer-readable recording medium storing a program configured to cause a computer to execute the processes of:
accepting slip information that associates and holds work item information indicating a work item and a work result candidate(s);
registering the work result candidate(s) included in the slip information in a dictionary, in association with the work item or the slip information;
associating and storing the slip information and the dictionary; and
transmitting the slip information together with the associated dictionary when transmitting the slip information.

26. A non-transitory computer-readable recording medium storing a program configured to cause a computer to execute the processes of:
obtaining slip information including work item information indicating a work item and a dictionary associated with the slip information;
presenting the work item information;
performing speech recognition of a speech input accepted for the work item information, using the dictionary; and
holding a result of the speech recognition, as a work result with respect to the work item information.
